(19) United States
(12) Patent Application Publication
(10) Pub. No.: US 2018/0368178 A1
(43) Pub. Date: Dec. 20, 2018

(54) Wireless Local Area Network Communication Method and Communication Device, and Station

(71) Applicant: Meizu Technology Co., Ltd., Zhuhai, Guangdong (CN)

(72) Inventor: Xiandong Dong, Zhuhai, Guangdong (CN)

(21) Appl. No.: 15/781,315

(22) PCT Filed: Dec. 7, 2016
(86) PCT No.: PCT/CN2016/108962

§ 371 Date: Jun. 4, 2018

(30) Foreign Application Priority Data
Dec. 28, 2015 (CN) 201511016460.4

(51) Int. Cl. H04W 74/00; H04W 74/08; H04W 72/04

(52) U.S. Cl. CPC H04W 74/006; H04W 84/12; H04W 72/0453; H04W 74/0833

(57) ABSTRACT

The present invention provides a wireless local area network communication method and communication device, and a station. The wireless local area network communication method comprises: receiving a message frame sent by an access point with a station which supports a UL OFDMA mechanism, wherein the message frame contains an OFDMA random access contention period field, and the OFDMA random access contention period field indicates that the station is capable of contending for accessing a channel within a contention period indicated by the OFDMA random access contention period field; and setting a network allocation vector to be idle within the contention period indicated by the OFDMA random access contention period field with the station, wherein the station has been allocated with a bandwidth resource. The technical solution of the present invention realizes correct setting of an NAV by the station and ensures that a UL OFDMA mechanism is applied, thereby improving the utilization efficiency of a frequency spectrum, and indirectly improving the throughput of the system.

### FIELD OF THE INVENTION

The present invention relates to the technical field of communication, and specifically relates to a wireless local area network communication method, a wireless local area network communication device, and a station.

### BACKGROUND OF THE INVENTION

On May 2013, IEEE 802.11 established the research group HEW (High efficiency WLAN, IEEE 802.11ax) of the next generation of Wi-Fi technology, namely, IEEE 802.11ax, with the main research point of improving the throughput of the existing Wi-Fi technology, improving the effective utilization rate of the frequency spectrum, improving the user experience and quality of service (QoE), and adapting to a more intensive communication environment than the existing Wi-Fi technology.

In the IEEE 802.11ax standard, it is specified that the OFDMA (Orthogonal Frequency Division Multiple Access, orthogonal frequency division multiple access) technology is adopted, so that multiple users may establish communication with an AP (Access Point, access point) at the same time, that is, an UL OFDMA (Uplink Orthogonal Frequency Division Multiple Access) mechanism, in this way, multiple STAs (Stations, stations) can simultaneously send their cached uplink data, and it is specified that the STAs need to use the OFDMA Back-off (back-off) mechanism to transmit uplink resources. However, it is not specified in the formulation of the Wi-Fi standard that how the STAs access the channel during the OFDMA Back-off, i.e., how to set an NAV (Network Allocation Vector).

### SUMMARY OF THE INVENTION

Just on the basis of at least one of the above technical problems, the present invention proposes a novel wireless local area network communication solution, which realizes correct setting of an NAV by a station and ensures that an UL OFDMA mechanism is applied, thereby improving the utilization efficiency of a frequency spectrum, and indirectly improving the throughput of the system.

In view of this, according to a first aspect of the present invention, a wireless local area network communication method is provided, including: receiving a message frame sent by an access point with a station which supports a UL OFDMA mechanism, wherein the message frame contains an OFDMA random access contention period field, and the OFDMA random access contention period field indicates that the station is capable of contending for accessing a channel within a contention period indicated by the OFDMA random access contention period field; and setting a network allocation vector to be idle within the contention period indicated by the OFDMA random access contention period field with the station, wherein the station has been allocated with a bandwidth resource.

In this technical solution, the station which supports the UL OFDMA mechanism receives the message frame sent by the access point, and the message frame contains the

OFDMA random access contention period field, so that the station contends for accessing the channel within the contention period indicated by the OFDMA random access contention period field, so that the station can set the network allocation vector to be idle after receiving the message frame and being allocated with the bandwidth resource, and then the station can contend for accessing the channel within an OFDMA Back-off period, correct setting of the NAV by the station is achieved, and the application of the UL OFDMA mechanism is ensured, thereby improving the utilization efficiency of the frequency spectrum, and indirectly improving the throughput of the system.

The OFDMA Back-off mechanism is mainly a random access process initiated after the station receives a trigger frame, where the access point adds a parameter to the trigger frame sent to the station, which is specifically as follows: when the station has data to send, if it is detected that the channel is busy, a random number N is selected from 0 to an OFDMA contention window and channel detection is continued; if it is detected again that the channel is busy, N remains unchanged, and if it is detected that the channel is idle, then 1 is reduced from N; when N=0, if it is detected again that the channel is idle, data is transmitted, and if it is detected again that the channel is busy, a random number is selected again, and the above process is executed again.

According to one embodiment of the present invention, the message frame further contains information of the bandwidth resource allocated by the access point to the station. In the present embodiment, the access point may directly allocate the bandwidth resource to the station in the message frame.

According to another embodiment of the present invention, the method further includes: receiving a resource message allocation frame sent by the access point with the station, wherein the resource message allocation frame contains information of the bandwidth resource allocated by the access point to the station. In the present embodiment, the access point may separately send the resource message allocation frame to the station so as to allocate the bandwidth resource to the station; and the access point may also send the resource allocation message frame to the station before the message frame is sent, and the resource allocation message frame is a broadcast message frame or a multicast message frame.

The bandwidth resource indicates the access channel bandwidth allocated by the AP to the station, such as 20 MHz channel bandwidth; and it may also contain spatial stream information.

All STAs allocated with the bandwidth resources set their own NAVs to be idle within the OFDMA Back-off period, indicating that they can contend for accessing the channel within this period, while other STAs that are not allocated with the bandwidth resources set their own NAVs to be busy within the OFDMA Back-off period, indicating that they cannot contend for accessing the channel within this period in order to avoid bringing interference to the communication of the STAs allocated with the bandwidth resources.

In any of the foregoing technical solutions, preferably, the OFDMA random access contention period field further includes start time information of an OFDMA random access contention period and duration information of the OFDMA random access contention period.

In any of the foregoing technical solutions, preferably, the message frame is a beacon frame.

According to a second aspect of the present invention, a wireless local area network communication device is further provided, including: a receiving unit for receiving a message frame sent by an access point, wherein the message frame contains an OFDMA random access contention period field, and the OFDMA random access contention period field indicates that a station supporting a UL OFDMA mechanism is capable of contending for accessing a channel within a contention period indicated by the OFDMA random access contention period field; and a processing unit for setting a network allocation vector to be idle within the contention period indicated by the OFDMA random access contention period field, wherein the station has been allocated with a bandwidth resource.

In this technical solution, the station which supports the UL OFDMA mechanism receives the message frame sent by the access point, and the message frame contains the OFDMA random access contention period field, so that the station contends for accessing the channel within the contention period indicated by the OFDMA random access contention period field, so that the station can set the network allocation vector to be idle after receiving the message frame and being allocated with the bandwidth resource, and then the station can contend for accessing the channel within an OFDMA Back-off period, correct setting of the NAV by the station is achieved, and the application of the UL OFDMA mechanism is ensured, thereby improving the utilization efficiency of the frequency spectrum, and indirectly improving the throughput of the system.

According to one embodiment of the present invention, the message frame further contains information of the bandwidth resource allocated by the access point to the station. In the present embodiment, the access point may directly allocate the bandwidth resource to the station in the message frame.

According to another embodiment of the present invention, the receiving unit is further used for: receiving a resource message allocation frame sent by the access point, wherein the resource message allocation frame contains information of the bandwidth resource allocated by the access point to the station. In the present embodiment, the access point may separately send the resource message allocation frame to the station so as to allocate the bandwidth resource to the station. Specifically, the access point may also send the resource allocation message frame to the station before the message frame is sent, and the resource allocation message frame is a broadcast message frame or a multicast message frame.

The bandwidth resource indicates the access channel bandwidth allocated by the AP to the station, such as 20 MHz channel bandwidth; and it may also contain spatial stream information.

All STAs allocated with the bandwidth resources set their own NAVs to be idle within the OFDMA Back-off period, indicating that they can contend for accessing the channel within this period, while other STAs that are not allocated with the bandwidth resources set their own NAVs to be busy within the OFDMA Back-off period, indicating that they cannot contend for accessing the channel within this period in order to avoid bringing interference to the communication of the STAs allocated with the bandwidth resources.

In any of the foregoing technical solutions, preferably, the OFDMA random access contention period field further includes start time information of an OFDMA random access contention period and duration information of the OFDMA random access contention period.

In any of the foregoing technical solutions, preferably, the message frame is a beacon frame.

According to a third aspect of the present invention, a station is further provided, including the wireless local area network communication device in any of the foregoing technical solutions.

Through the above technical solutions, correct setting of the NAV by the station is achieved, and the application of the UL OFDMA mechanism is ensured, thereby improving the utilization efficiency of the frequency spectrum, and indirectly improving the throughput of the system.

### BRIEF DESCRIPTION OF THE DRAWINGS

FIG. 1 shows a schematic flow diagram of a wireless local area network communication method according to one embodiment of the present invention;

FIG. 2 shows a schematic block diagram of a wireless local area network communication device according to an embodiment of the present invention;

FIG. 3 shows a schematic block diagram of a station according to an embodiment of the present invention;

FIG. 4 shows a schematic diagram illustrating when a station according to an embodiment of the present invention contends for accessing a channel;

FIG. 5 shows a schematic flow diagram of a wireless local area network communication method according to another embodiment of the present invention.

### DETAILED DESCRIPTION OF THE EMBODIMENTS

In order to more clearly understand the above objects, features and advantages of the present invention, the present invention will be further described in detail below in conjunction with the drawings and specific embodiments. It should be noted that the embodiments of the present application and the features in the embodiments may be combined with each other without conflict.

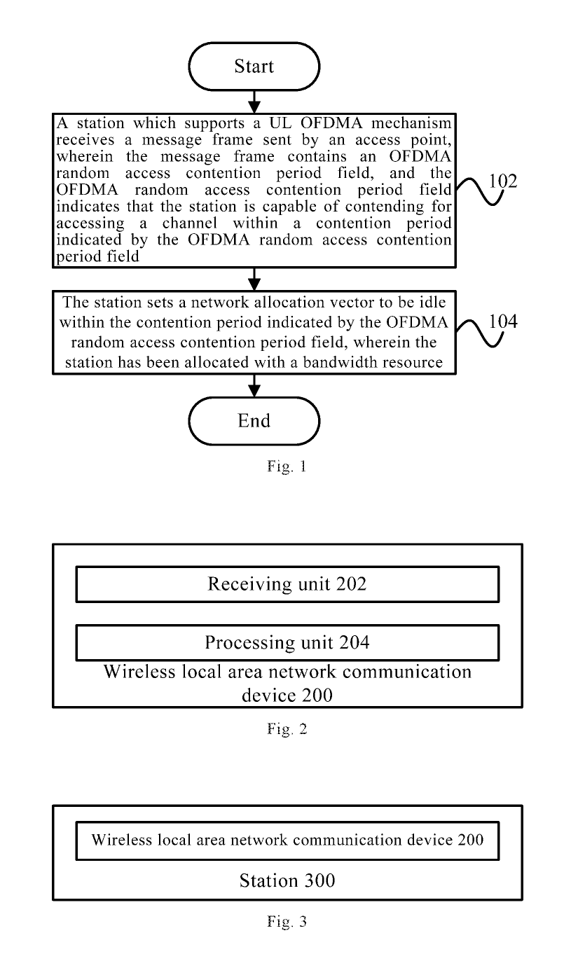

In the following description, many specific details are set forth in order to fully understand the present invention. However, the present invention may also be implemented in other manners than those described herein. Therefore, the scope of protection of the present invention is not limited to the following specific embodiments disclosed below. FIG. 1 shows a schematic flow diagram of a wireless local area network communication method according to one embodiment of the present invention.

As shown in FIG. 1, the wireless local area network communication method according to one embodiment of the present invention includes:

step 102, receiving a message frame sent by an access point with a station which supports a UL OFDMA mechanism, wherein the message frame contains an OFDMA random access contention period field, and the OFDMA random access contention period field indicates that the station is capable of contending for accessing a channel within a contention period indicated by the OFDMA random access contention period field; and

step 104, setting a network allocation vector to be idle within the contention period indicated by the OFDMA random access contention period field with the station, wherein the station has been allocated with a bandwidth resource.

The communication method shown in FIG. 1 may be executed by a mobile phone or a PDA (Personal Digital Assistant,), etc.

In this technical solution, the station which supports the UL OFDMA mechanism receives the message frame sent by the access point, and the message frame contains the OFDMA random access contention period field, so that the station contends for accessing the channel within the contention period indicated by the OFDMA random access contention period field, so that the station can set the network allocation vector to be idle after receiving the message frame and being allocated with the bandwidth resource, and then the station can contend for accessing the channel within an OFDMA Back-off period, correct setting of the NAV by the station is achieved, and the application of the UL OFDMA mechanism is ensured, thereby improving the utilization efficiency of the frequency spectrum, and indirectly improving the throughput of the system.

The OFDMA Back-off mechanism is mainly a random access process initiated after the station receives a trigger frame, where that the access point adds a parameter in the trigger frame sent to the station, which is specifically as follows: when the station has data to send, if it is detected that the channel is busy, a random number N is selected from 0 to an OFDMA contention window and channel detection is continued; if it is detected again that the channel is busy, N remains unchanged, and if it is detected that the channel is idle, then 1 is reduced from N; when N=0, if it is detected again that the channel is idle, data is transmitted, and if it is detected again that the channel is busy, a random number is selected again, and the above process is executed again.

According to one embodiment of the present invention, the message frame further contains information of the bandwidth resource allocated by the access point to the station. In the present embodiment, the access point may directly allocate the bandwidth resource to the station in the message frame.

According to another embodiment of the present invention, the method further includes: receiving a resource message allocation frame sent by the access point with the station, wherein the resource message allocation frame contains information of the bandwidth resource allocated by the access point to the station. In the present embodiment, the access point may separately send the resource message allocation frame to the station so as to allocate the bandwidth resource to the station. Specifically, the access point may send the resource allocation message frame to the station before the message frame is sent, and the resource allocation message frame is a broadcast message frame or a multicast message frame.

The bandwidth resource indicates the access channel bandwidth allocated by the AP to the station, such as 20 MHz channel bandwidth; and it may also contain spatial stream information.

All STAs allocated with the bandwidth resources set their own NAVs to be idle within the OFDMA Back-off period, indicating that they can contend for accessing the channel within this period, while other STAs that are not allocated with the bandwidth resources set their own NAVs to be busy within the OFDMA Back-off period, indicating that they cannot contend for accessing the channel within this period in order to avoid bringing interference to the communication of the STAs allocated with the bandwidth resources.

In any of the foregoing technical solutions, preferably, the OFDMA random access contention period field further includes start time information of an OFDMA random access contention period and duration information of the OFDMA random access contention period.

In any of the foregoing technical solutions, preferably, the message frame is a beacon frame

FIG. 2 shows a schematic block diagram of a wireless local area network communication device according to an embodiment of the present invention;

As shown in FIG. 2, the wireless local area network communication device according to the embodiment of the present invention includes a receiving unit 202 and a processing unit 204.

The receiving unit 202 is used for receiving a message frame sent by an access point, wherein the message frame contains an OFDMA random access contention period field, and the OFDMA random access contention period field indicates that a station supporting a UL OFDMA mechanism can contend for accessing a channel within a contention period indicated by the OFDMA random access contention period field; and

the processing unit 204 is used for setting a network allocation vector to be idle within the contention period indicated by the OFDMA random access contention period field, wherein the station has been allocated with a bandwidth resource.

The receiving unit 202 may be a receiver or an antenna when being implemented; and the processing unit 204 may be a central processor or a baseband processor when being implemented.

In this technical solution, the station which supports the UL OFDMA mechanism receives the message frame sent by the access point, and the message frame contains the OFDMA random access contention period field, so that the station contends for accessing the channel within the contention period indicated by the OFDMA random access contention period field, so that the station can set the network allocation vector to be idle after receiving the message frame and being allocated with the bandwidth resource, and then the station can contend for accessing the channel within an OFDMA Back-off period, correct setting of the NAV by the station is achieved, and the application of the UL OFDMA mechanism is ensured, thereby improving the utilization efficiency of the frequency spectrum, and indirectly improving the throughput of the system.

According to one embodiment of the present invention, the message frame further contains information of the bandwidth resource allocated by the access point to the station. In the present embodiment, the access point may directly allocate the bandwidth resource to the station in the message frame.

According to another embodiment of the present invention, the receiving unit 202 is further used for: receiving a resource message allocation frame sent by the access point, wherein the resource message allocation frame contains information of the bandwidth resource allocated by the access point to the station. In the present embodiment, the access point may separately send the resource message allocation frame to the station so as to allocate the bandwidth resource to the station. Specifically, the access point may send the resource allocation message frame to the station before the message frame is sent, and the resource allocation message frame is a broadcast message frame or a multicast message frame.

The bandwidth resource indicates the access channel bandwidth allocated by the AP to the station, such as 20 MHz channel bandwidth; and it may also contain spatial stream information.

All STAs allocated with the bandwidth resources set their own NAVs to be idle within the OFDMA Back-off period, indicating that can contend for accessing the channel within this period, while other STAs that are not allocated with the bandwidth resources set their own NAVs to be busy within the OFDMA Back-off period, indicating that they cannot contend for accessing the channel within this period in order to avoid bringing interference to the communication of the STAs allocated with the bandwidth resources.

In any of the foregoing technical solutions, preferably, the OFDMA random access contention period field further includes start time information of an OFDMA random access contention period and duration information of the OFDMA random access contention period.

In any of the foregoing technical solutions, preferably, the message frame is a beacon frame.

FIG. 3 shows a schematic block diagram of a station according to an embodiment of the present invention.

As shown in FIG. 3, the station 300 according to the embodiment of the present invention includes the wireless local area network communication device 200 as shown in FIG. 2.

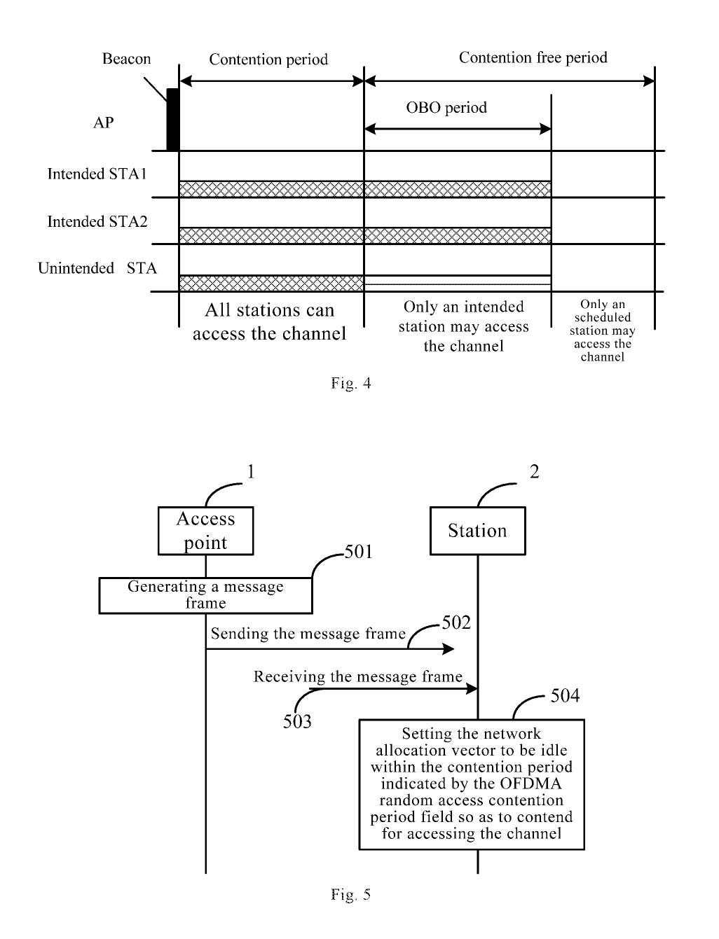

The technical solution of the present invention will be described in detail with reference to FIGS. 4 and 5.

The technical solution of the present invention is mainly applied to the HE (High Efficiency) STAs that have been allocated with uplink resources by the AP, and the NAVs may be set to be idle within the OFDMA Back-off (hereinafter referred to as OBO) period in a CFP (Contention-Free Period), and the other HE STAs that are not allocated the uplink resources set the NAVs to be busy.

The specific steps are as follows:

1. The AP defines a new information element IE, packages the information element in a Beacon frame, and sends the same to the station, wherein the format of the information element is shown in Table 1:

TABLE 1

| | Element | | OBO | OBO | OBO | OBO |
|---|---|---|---|---|---|---|
| | ID | Length | count | interval | start time | duration |
| Byte□ | 1 | 1 | 1 | 1 | 2 | 2 |

As shown in Table 1, OBO count indicates how many OBOs will occur before the next CFP period; OBO start time indicates the start time of OBO within the CFP; OBO duration indicates the duration of the OBO within the CFP; and OBO interval indicates the interval of the OBO within the CFP.

2. HE STAs set the NAV

If the STAs have been allocated with uplink resources, the STAs set the NAVs to be idle within the OBO period; if the HE STAs are not allocated with the uplink resources, the STAs set their own NAVs to be busy, that is, the STAs cannot access the channel within the OBO period.

3. Legacy (backward compatible) STAs set the NAV

The AP may set the OBO parameter value according to the value of the CFP parameter, and here it is specified that the legacy STAs cannot access the channel within the period.

Specifically, as shown in FIG. 4, the AP may set a field in the beacon frame to indicate that the Intended STAs contend for accessing the channel within the OBO period specified within the contention-free period (CFP). Within the contention period, all stations can contend for accessing the channel. Within the OBO period in the CFP, only the Intended STAs can contend for accessing the channel, so the Intended STAs set their own NAVs to be idle within the OBO period, the other STAs set their own NAVs to be busy; at other time within the CFP, only the scheduled station can contend for accessing the channel, and the STAs including the Intended STAs set their own NAVs to be idle within this period.

FIG. 5 shows a schematic flow diagram of a wireless local area network communication method according to another embodiment of the present invention.

As shown in FIG. 5, the wireless local area network communication method according to another embodiment of the present invention includes:

step 501, an access point 1 generates a message frame, wherein the message frame contains an OFDMA random access contention period field, and the OFDMA random access contention period field indicates that a station that supports a UL OFDMA mechanism can contend for accessing a channel within a contention period indicated by the OFDMA random access contention period field.

Step 502, the access point 1 sends the message frame.

Step 503, a station 2 receives the message frame.

Step 504, the station 2 sets a network allocation vector to be idle within the contention period indicated by the OFDMA random access contention period field so as to contend for accessing the channel. It should be noted that when the station 2 contends for accessing the channel, it has already obtained the bandwidth resource allocated by the access point 1, and the information of the bandwidth resource may be indicated to the station 2 by the access point 1 in the generated message frame and may also be indicated to the station 2 by the access point 1 in a resource allocation message frame sent to the station 2.

The technical solutions of the present invention are described in detail above with reference to the drawings. The present invention provides a new wireless local area network communication scheme, so that after receiving the message frame sent by the access point, the station may set the network allocation vector to be idle if it has been allocated with the bandwidth resource, then the station can contend for accessing the channel within the OFDMA Back-off period, correct setting of the NAV by the station is achieved, and the application of the UL OFDMA mechanism is ensured, thereby improving the utilization efficiency of the frequency spectrum, and indirectly improving the throughput of the system.

Described above are merely preferred embodiments of the present invention, which are not intended to limit the present invention. For those skilled in the art, the present invention may have various changes and modifications. Any modifications, equivalent substitutions and improvements made within the spirit and principle of the present invention shall fall within the protection scope of the present invention.

1. A wireless local area network communication method, comprising:
receiving a message frame sent by an access point with a station which supports a UL OFDMA mechanism, wherein the message frame contains an OFDMA random access contention period field, and the OFDMA random access contention period field indicates that the station is capable of contending for accessing a channel within a contention period indicated by the OFDMA random access contention period field; and
setting a network allocation vector to be idle within the contention period indicated by the OFDMA random access contention period field with the station, wherein the station has been allocated with a bandwidth resource.

2. The wireless local area network communication method according to claim 1, wherein the message frame further contains information of the bandwidth resource allocated by the access point to the station.

3. The wireless local area network communication method according to claim 1, further comprising:
receiving a resource message allocation frame sent by the access point with the station, wherein the resource message allocation frame contains information of the bandwidth resource allocated by the access point to the station.

4. The wireless local area network communication method according to claim 1, wherein the OFDMA random access contention period field further comprises start time information of an OFDMA random access contention period and duration information of the OFDMA random access contention period.

5. The wireless local area network communication method according to claim 1, wherein the message frame is a beacon frame.

6. A wireless local area network communication device, comprising:
a receiving unit for receiving a message frame sent by an access point, wherein the message frame contains an OFDMA random access contention period field, and the OFDMA random access contention period field indicates that a station supporting a UL OFDMA mechanism is capable of contending for accessing a channel within a contention period indicated by the OFDMA random access contention period field; and
a processing unit for setting a network allocation vector to be idle within the contention period indicated by the OFDMA random access contention period field, wherein the station has been allocated with a bandwidth resource.

7. The wireless local area network communication device according to claim 6, wherein the message frame further contains information of the bandwidth resource allocated by the access point to the station.

8. The wireless local area network communication device according to claim 6, wherein the receiving unit is further used for:
receiving a resource message allocation frame sent by the access point, wherein the resource message allocation frame contains information of the bandwidth resource allocated by the access point to the station.

9. The wireless local area network communication device according to claim 6, wherein the OFDMA random access contention period field further comprises start time information of an OFDMA random access contention period and duration information of the OFDMA random access contention period.

10. The wireless local area network communication device according to claim 6, wherein the message frame is a beacon frame.

11. A station, comprising the wireless local area network communication device according to claim 6.
